(19) United States
(12) Patent Application Publication
(10) Pub. No.: US 2009/0167738 A1
(43) Pub. Date: Jul. 2, 2009

(54) IMAGING DEVICE AND METHOD

(75) Inventor: Yoshiharu Gotanda, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/339,272

(22) Filed: Dec. 19, 2008

(30) Foreign Application Priority Data
Dec. 27, 2007 (JP) 2007-336570

(51) Int. Cl. G09G 5/00

(52) U.S. Cl. 345/207

(57) ABSTRACT

An imaging device capable of sensing overall luminous intensity and determining whether to turn off an illumination device. The imaging device can capture a moving picture, and includes a light emitting unit for emitting light on a subject, a light measuring unit for detecting the brightness level of the subject, and a light emitting intensity controller for controlling the light emitting intensity from the light emitting unit. The light emitting intensity controller controls the light emitting unit to emit light having different intensities on the subject for a period of time corresponding to at least one frame, and reduces the light emitting intensity of the light emitting unit or adjusts the light emitting intensity to a value of ‘0’ based on the brightness level of the subject on which the light having different intensities is emitted.

### CROSS-REFERENCE TO RELATED PATENT APPLICATION

This application claims the benefit of Japanese Patent Application No. 2007-336570, filed on Dec. 27, 2007, in the Japanese Patent Office, the entire content of which is incorporated herein by reference.

### BACKGROUND OF THE INVENTION

1. Field of the Invention

The present invention relates to an imaging device. More particularly, the present invention relates to an imaging device capable of sensing overall luminous intensity and determining whether to turn off an illumination device.

2. Description of the Related Art

As rapid advances in the technologies to manufacture digital devices and to process information facilitate acquiring high-performance and low-cost digital devices, various types of digital devices have become widespread. In particular, digital still cameras are one type of such digital devices. In general, a flash is built in a digital device having a photographing function, e.g., digital still cameras (hereinafter referred to as “imaging devices”), as an illumination device for illuminating a subject. Also, imaging devices that have recently been developed have a moving picture photographing function.

However, an illumination device, such as a flash, which is built in such imaging devices, is not appropriate for photographing a moving picture since the intensity of light emitted from the illumination device is high but cannot be continuously incident on a subject. Thus, there is a need to develop an illumination device capable of continuously emitting light when photographing a moving picture, and an apparatus for controlling the illumination device. For example, much attention has been paid to light emitting diodes (LEDs) as such an illumination device. LEDs can continuously illuminate a subject during periods of forming a plurality of frames by photographing a moving picture. Also, LEDs are advantageous in terms of high brightness and low power consumption. However, even if LEDs are established as an illumination device of an imaging device, power consumption of the imaging device is still high. Therefore, there is still a growing need for the development of a technique of appropriately controlling the turning on/off of an illumination device in order to save power consumption in an imaging device.

In this regard, Japanese Patent Laid-Open Publication number 2003-309765 (document 1), discloses an imaging device and a camera built-in mobile phone, as well as a technique of turning off an illumination device prior to automatic exposure by a camera, after the illumination device is turned on. As described in document 1, a user turns on an illumination device by manipulating manipulation keys.

As another example, Japanese Patent Laid-Open Publication number 2003-348440 (document 2), discloses a method of controlling an imaging apparatus using an illumination device, and also discloses that a user determines whether illumination is needed. As described in document 2, a user controls the operations of an imaging device, a display device and an illumination device by selectively manipulating manipulation buttons during use of the imaging device. In particular, the operations of the imaging device and turning on of the illumination device are controlled via the manipulation buttons.

As another example, Japanese Patent Laid-Open Publication number 2005-165204 (document 3), discloses a photographic illumination device, a camera system and a camera, a method of controlling a current-controlled light emitting device that emits light toward a subject, and also a method of controlling a driving current to be supplied to the light emitting device. As described in document 3, the distance between the camera and a main subject is detected, and the light emitting device is controlled to emit light such that the luminous intensity of the light emitting device is calculated based on the distance between the camera and the main subject, an exposure time, an iris value, and photographing sensitivity.

In the case of the techniques disclosed in documents 1 and 2 discussed above, a user must manually turn on or off an illumination device according to his or her determination, and it is difficult to control the illumination device to be turned on when illumination is needed in order to photograph a moving picture. In particular, it is difficult to turn off the illumination device by automatically sensing whether luminous intensity is high. In the case of the technique disclosed in document 3 discussed above, light-emitting intensity can be controlled in consideration of the distance between a camera and a main subject but it is difficult to turn off the illumination device or reduce the light emitting intensity of the illumination device according to luminous intensity. Furthermore, a combination of the above techniques does not provide a solution to difficulties in controlling an illumination device by automatically sensing luminous intensity. In addition, it is very difficult to determine the luminous intensity of illumination on a subject by distinguishing between the intensity of light emitted from an illumination device of an imaging device and the intensity of external light, and to turn off the illumination device or control the light emitting intensity of the illumination device based on the determination result.

### SUMMARY OF THE INVENTION

The present invention provides an imaging device capable of sensing the luminous intensity by external light in order to determine whether to illuminate, and controlling an illumination device based on the sensing result.

Accordingly, an embodiment of the present invention provides an imaging device including an imaging unit for detecting luminous intensity, a light emitting unit for emitting light on a subject while the imaging unit continuously detects the luminous intensity for a number of times, a light measuring unit for detecting a brightness level of the subject according to the luminous intensity detected by the imaging unit, and a light emitting intensity controller for controlling the intensity of light emitted from the light emitting unit. The light emitting intensity controller controls the light emitting unit to emit light having different intensities on the subject while the imaging unit detects the luminous intensity at least once, and reduces the light emitting intensity of the light emitting unit or adjusts the light emitting intensity to a value of ‘0’ based on the brightness level of the subject on which the light having different intensities is emitted.

The imaging device may further include a luminous intensity calculation unit for calculating a luminous intensity by external light by excluding the luminous intensity of the light emitted from the light emitting unit from the luminous intensity detected by the imaging unit, based on the brightness level of the subject on which the light having different intensities is emitted, wherein the light emitting intensity controller reduces the light emitting intensity or adjusts the light emitting intensity to the value of ‘0’ based on the calculated the luminous intensity by external light. The imaging device may also include a moving picture reproduction unit continuously displaying image frames obtained based on brightness levels corresponding to luminous intensities being continuously detected by the imaging unit for the number of times, wherein the moving picture reproduction unit does not display an image frame corresponding to the brightness level of the subject on which the light having different intensities is emitted.

The imaging device may further include a frame memory having a plurality of memory regions storing the image frames; and a frame recording unit recording the image frames on the memory regions in a predetermined order. The frame recording unit overwrites a memory region, from among the memory regions, to store the image frame corresponding to the brightness level of the subject on which the light having different intensities is emitted with a subsequent image frame in the predetermined order, and the moving picture reproduction unit displays the image frames stored in the memory regions in the predetermined order.

Accordingly, an imaging device according to the present invention can determine whether to turn on an illumination device by distinguishing between the intensity of light emitted from the imaging device and the intensity of external light, and thus, turn off the illumination device or reduce the light emitting intensity of the illumination device based on the determination result. Also, it is possible to prevent a moving picture from being unclear due to an inclusion of an image frame of a subject on which light having different intensities is incident in order to determine luminous intensity, by controlling the image frame not to be displayed when displaying the moving picture. During the controlling, only a memory region storing the image frame is overwritten when image frames are recording on a plurality of memory regions of a frame memory in a predetermined order. Therefore, it is easy to prevent the image frame from being displayed when the image frames are read and displayed in the predetermined order.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an example of an imaging device according to an embodiment of the present invention;

FIG. 2 is a diagram illustrating an example of a method of dividing an imaging surface into a plurality of image regions in the imaging device illustrated in FIG. 1, according to an embodiment of the present invention;

FIG. 3 illustrates an example of a light measuring unit of the imaging device illustrated in FIG. 1, according to an embodiment of the present invention;

FIG. 4 is an example of a circuit diagram of a light emitting intensity control device of the imaging device illustrated in FIG. 1, according to an embodiment of the present invention:

FIG. 5 is a graph illustrating an example of the relationship between the magnitude of a control signal and light emitting intensity, according to an embodiment of the present invention;

FIG. 6 is a timing diagram illustrating an example of a signal synchronization method used by the imaging device illustrated in FIG. 1, according to an embodiment of the present invention;

FIG. 7 is a flowchart illustrating an example of a method of processing illumination on a moving picture in the imaging device illustrated in FIG. 1, according to an embodiment of the present invention;

FIG. 8 is a flowchart illustrating an example of an operation of determining overall luminous intensity by the imaging device of FIG. 1, according to an embodiment of the present invention;

FIG. 9 is a flowchart illustrating an example of an operation of determining the luminous intensity by external light by the imaging device of FIG. 1, according to an embodiment of the present invention;

FIG. 10 is a flowchart illustrating an example of an operation of calculating light emitting intensity by the imaging device of FIG. 1, according to an embodiment of the present invention; and

FIG. 11 is a flowchart illustrating an example of the operation of a moving picture sequencer of the imaging device 100 illustrated in FIG. 1, according to an embodiment of the present invention.

### DETAILED DESCRIPTION OF THE EMBODIMENTS

Hereinafter, exemplary embodiments of the present invention will be described in detail with reference to the accompanying drawings. Like reference numerals denote like elements throughout the drawings.

In the present specification, the term, “luminous intensity” may be understood as the intensity of light reflected from a subject since luminous intensity is measured by an imaging device according to an embodiment of the present invention.

An imaging device according to an embodiment of the present invention will now be described. The imaging device according to this embodiment can save power consumption by determining luminous intensity when capturing a moving picture, and turning off an illumination device or reducing light emitting intensity of the illumination device when the luminous intensity of illumination from external light is high. In particular, the imaging device is capable of distinguishing between the luminous intensity of illumination from the imaging device and the luminous intensity of illumination from external light. Accordingly, it is possible to turn off the illumination device or reduce the light emitting intensity of the illumination device when the luminous intensity of illumination from the external light is high.

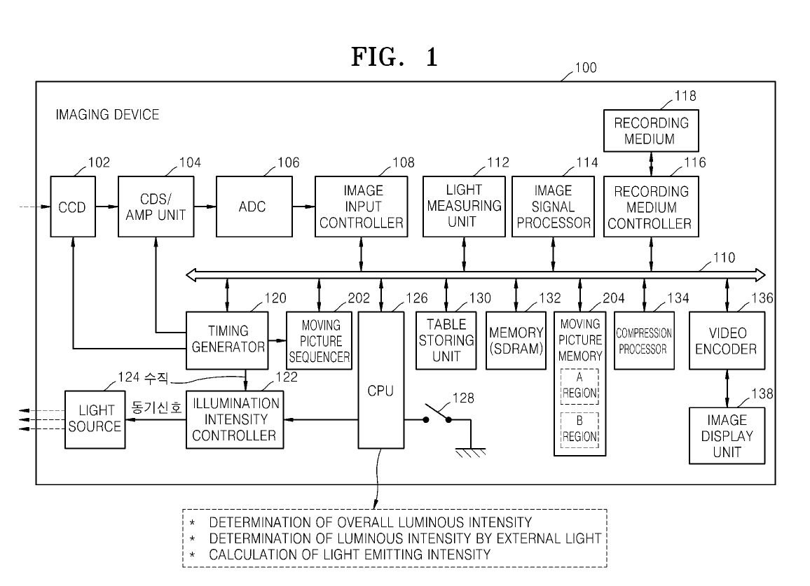

FIG. 1 is a block diagram of an imaging device 100 according to an embodiment of the present invention. The imaging device 100 includes a charge-coupled device (CCD) 102, a correlated double sampling/amplifier (CDS/AMP) unit 104, an analog to digital converter (ADC) 106, an image input controller 108, a bus 110, a light measuring unit 112, an image signal processor 114, a recording medium controller 116, a recording medium 118, a timing generator 120, an illumination intensity controller 122, a light source 124, a central processing unit (CPU) 126, a shutter 128, a memory 132, a compression processor 134, a video encoder 136, an image display unit 138, a moving picture sequencer 202, and a moving picture memory 204.

The CCD 102 includes a plurality of photoelectric conversion units, each of which converts incident light thereupon into an electrical signal. In detail, the CCD 102 receives incident light thereon via a focusing optical system, and outputs an electrical signal according to the intensity of the incident light on each of the photoelectric conversion units. The CCD 102 is one type of imaging unit, and thus, the imaging device 100 may include another type of imaging unit, such as a complementary metal oxide semiconductor (CMOS), instead of the CCD 102.

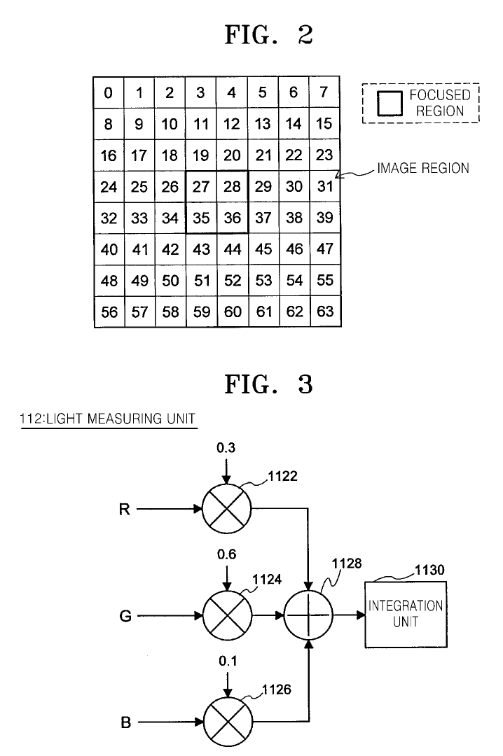

Also, as illustrated in FIG. 2, the CCD 102 may have an image-pickup surface divided into a plurality of image regions. FIG. 2 is a diagram illustrating an example of a method of dividing the imaging surface into the plurality of image regions, according to an embodiment of the present invention. Referring to FIG. 2, the image-pickup surface is divided into 64 image regions. For convenience of explanation, numbers 0 through 63 are respectively allocated to the 64 image regions. Hereinafter, an i^{th} image region may also be referred to as an i^{th} region.

Also, a focused region indicated with a bold box is set in the CCD 102. The focused region may be positioned at a center or another location of the CCD 102. For example, if the imaging device 100 has a function of detecting a characteristic part of a subject, the characteristic part may be set as the focused region. In FIG. 2, the focused region is set to include the image regions 27, 28, 35, and 36. Hereinafter, it is assumed that the focused region is located at the center of the CCD 102. An electrical signal output from each of the image regions of the CCD 102 is supplied to the CDS/AMP unit 104.

Referring back to FIG. 1, the CDS/AMP unit 104 may include a correlated double sampling (CDS) circuit and an amplifier (AMP). The CDS/AMP unit 104 removes a low-frequency noise component from the electrical signal received from the CCD 102, and amplifies the resultant electrical signal to a predetermined level. The electrical signal output from the CDS/AMP unit 104 is supplied to the ADC 106.

The ADC 106 is a converter that converts an analog signal into a digital signal. The ADC 106 converts the electrical signal received from the CDS/AMP unit 104 into a digital signal. The digital signal obtained by the ADC unit 106 is then supplied to the image input controller 108.

The image input controller 108 may create an image signal from the digital signal received from the ADC 106. The image input controller 108 converts the digital signal received from the ADC 106 in a format so that the image signal can be image-processed (hereinafter, into an image signal) and then outputs the resultant image signal to the image signal processor 114.

The bus 110 is a signal transmission path via which the constituent elements of the imaging device 100 are connected to each other. For example, the bus 110 allows the image input controller 108, the light measuring unit 112, the image signal processor 114, the recording medium controller 116, the timing generator 120, the CPU 126, a table storing unit 130, the memory 132, the compression processor 134, the video encoder 136, the moving picture sequencer 202, and the moving picture memory 204 to be connected to each other, so that a signal can be transmitted from one constituent element to another constituent element.

The light measuring unit 112 measures the brightness level (hereinafter may be referred to as a “luminance signal”) of each of the image regions of the CCD 102. The brightness level may be measured based on an electrical signal output from each of the image regions. Also, the light measuring unit 112 may measure the brightness level of each of the image regions by allocating a weight to the electrical signal output from each of the image regions according to color. For example, the light measuring unit 112 is as illustrated in FIG. 3.

Referring to FIG. 3, the light measuring unit 112 may include a plurality of multipliers 1122, 1124, and 1126, an adder 1128, and an integration unit 1130. The multiplier 1122 multiplies an R signal output from a red pixel by a weight coefficient Cr (=0.3) and inputs the resultant value into the adder 1128. The multiplier 1124 multiplies a G signal output from a green pixel by a weight coefficient Cg (=0.6) and inputs the resultant value into the adder 1128. The multiplier 1126 multiplies a B signal output from a blue pixel by a weight coefficient Cb (=0.1) and inputs the resultant value into the adder 1128.

The adder 1128 calculates a luminance signal Y by combining the R, G, B signals received from the multipliers 1122 through 1126, and supplies the luminance signal Y to the integration unit 1130. The integration unit 1130 integrates the luminance signal Y received from the adder 1128 with respect to some or all of the image regions, and outputs a brightness level related to some or all of the image regions. In detail, the light measuring unit 112 calculates a luminance signal Y for each of the image regions by using Equation (1) below. For example, the light measuring unit 112 may calculate the brightness level of a focused region and the brightness level of the regions other than the focused region (hereinafter referred to as “residual region”).

Y=Cr×R+Cg×G+Cb×B (1)

Referring back to FIG. 1, the image signal processor 114 can generate image data by synthesizing image signals of the image regions, which are received from the image input controller 108. The image data generated by the image signal processor 114 is stored in the memory 132 or the moving picture memory 204. Also, the image signal processor 114 may generate moving picture data consisting of frames that are image data accumulated in the memory 132 or the moving picture memory 204. Also, the image signal processor 114 can create moving picture data, together with the compression processor 134, the video encoder 136 and the moving picture sequencer 202. For example, the image signal processor 114 supplies image data to the moving picture sequencer 202, and can create moving picture data by using the moving picture sequencer 202, as will later be described in detail.

When using the moving picture memory 204 having a plurality of data storage regions, the image signal processor 114 records frames in the data storage regions in a predetermined order. For example, if the moving picture memory 204 has two data storage regions, e.g., A and B regions, the image signal processor 114 alternately records frames in the A and B regions. However, in the case of a frame of forming by photographing a subject on which light having different light emitting intensities is incident in order to determine luminous intensity, the image signal processor 114 writes a subsequent frame on the frame without changing data storage regions in order to record the subsequent frame.

The recording medium controller 116 writes data to or reads data from the recording medium 118. Data is written to the recording medium 118. For example, the recording medium 118 may be a memory device included in the imaging device 100 or a recording media that can be attached to or detached from the imaging device 100. The recording medium 118 may be an optical recording medium (CD, DVD, etc.), a magneto-optical memory medium, a magnetic memory medium, or a semiconductor memory medium.

The timing generator 120 can control a noise reduction circuit included in the CDS/AMP unit 104 while controlling the duration of exposure of each pixel of the CCD 102 or a timing of charge reading. To this end, the timing generator 120 respectively supplies timing signals to the CCD 102 and the CDS/AMP unit 104. Also, the timing generator 120 transmits a vertical synchronization signal related to charge reading and received from the CCD 102, to the illumination intensity controller 122 and the moving picture sequencer 202.

The illumination intensity controller 122 controls the intensity of light emitted from the light source 124. The illumination intensity controller 122 is an example of a light emitting intensity controller. The illumination intensity controller 122 controls the light source 124 to be turned off or the light emitting intensity of the light source 124 to be reduced according to the results of determining overall luminous intensity and determining the luminous intensity by external light by the CPU 126, as will later be described in detail. In this case, the illumination intensity controller 122 controls the light source 124 to be turned off or the light emitting intensity of the light source 124 to be reduced by stages until the light emitting intensity reaches a predetermined level. Alternatively, the illumination intensity controller 122 may reduce the light emitting intensity by stages, in synchronization with a vertical synchronization signal received from the timing generator 120.

Since the illumination intensity controller 122 can be used in determining overall luminous intensity and the luminous intensity by external light, the luminous intensity by a subject on which light emitting intensity (hereinafter referred to as “the luminous intensity of a subject”) having different intensities is incident from the light source can be reduced by at least one frame. In this case, the illumination intensity controller 122 can reduce the light emitting intensity of the light source 124 by one frame, in synchronization with a vertical synchronization signal from the timing generator 120. Also, the light emitting intensity related to a frame is calculated using a function of calculating light emitting intensity in the CPU 126, as will be described later in detail.

The light source 124 is a device that illuminates a subject so as to photograph a still image or a moving picture of the subject. The light source 124 is an example of a light emitting unit. For example, the light source 124 may include a plurality of light sources each emitting red, green, or blue light. The light source 124 may be a combination of a plurality of light sources respectively emitting lights having different brightness or colors, or may be constructed using a light source emitting white light and color filters. The light source 124 may be formed using a light emitting device, such as a light emitting device (LED).

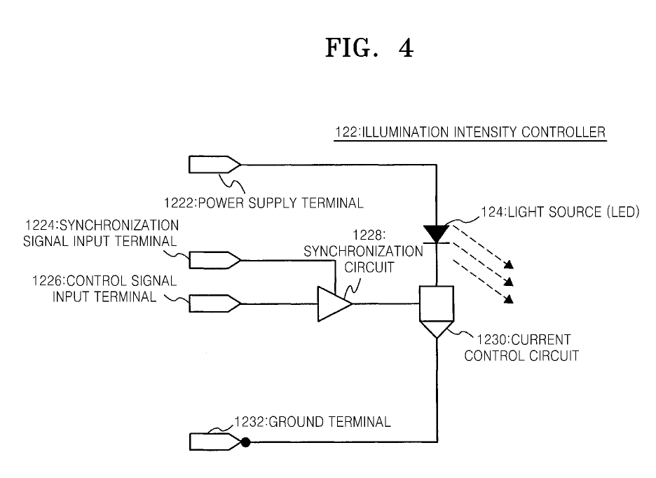

The circuit construction of a luminous intensity control device including the illumination intensity controller 122 and the light source 124 will now be described with reference to FIG. 4. FIG. 4 is a circuit diagram of a luminous intensity control device of the imaging device 100, according to an embodiment of the present invention.

As illustrated in FIG. 4, the illumination intensity controller 122 may include a power supply terminal 1222, a synchronization signal input terminal 1224, a control signal input terminal 1226, a synchronization circuit 1228, a current control circuit 1230, and a ground terminal 1232. The light source 124 is connected between the power supply terminal 1222 and the current control circuit 1230. Electric power is supplied to the power supply terminal 1222. A control signal from the CPU 126 is supplied to the control signal input terminal 1226. The ground terminal 1232 is grounded.

One end of the light source 124 is connected to the power supply terminal 1222 that supplies electrical power to the light source 124. The other end of the light source 124 is connected to the current control circuit 1230, and the amount of current is controlled by the current control circuit 1230. The current control circuit 1230 is connected to the synchronization circuit 1228, and the amount of current flowing through the current control circuit 1230 is controlled by a control signal output from the synchronization circuit 1228. The current control circuit 1230 is also connected to the ground terminal 1232.

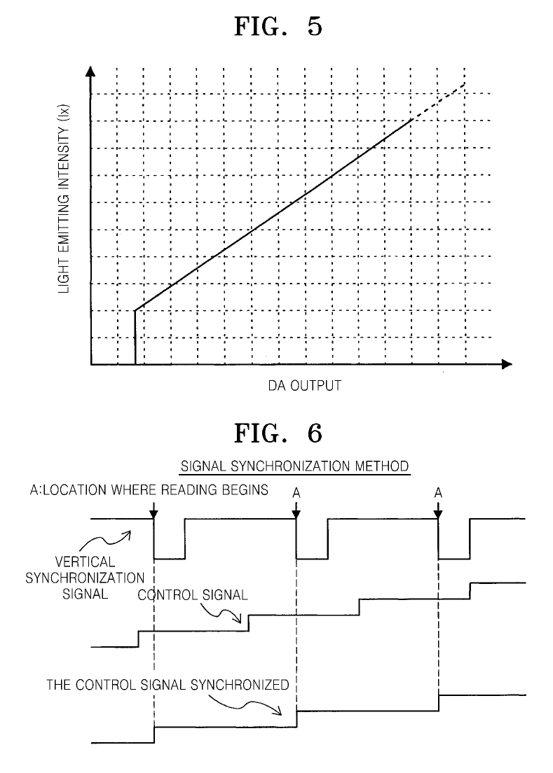

FIG. 5 is a graph illustrating an example of the relationship between the magnitude of a control signal supplied to the current control circuit 1230 and the intensity of light emitted from the light source 124. The graph of FIG. 5 shows that the intensity of light emitted from the light source 124 linearly increases when the magnitude of the control signal (DA output) supplied to the current control circuit 1230 is equal to or greater than a predetermined value. Accordingly, the intensity of light emitted from the light source 124 can be controlled by the control signal output from the synchronization circuit 1228 by connecting the current control circuit 1230 to the light source 124 in series.

Referring back to FIG. 4, one end of the synchronization circuit 1228 is connected to the current control circuit 1230 and another end is connected to the control signal input terminal 1226. A vertical synchronization signal received from the synchronization signal input terminal 1224 is supplied to the synchronization circuit 1228. The vertical synchronization signal is received from the timing generator 120. The synchronization circuit 1228 supplies a control signal received from the CPU 126 to the current control circuit 1230, in synchronization with the vertical synchronization signal received from the timing generator 120.

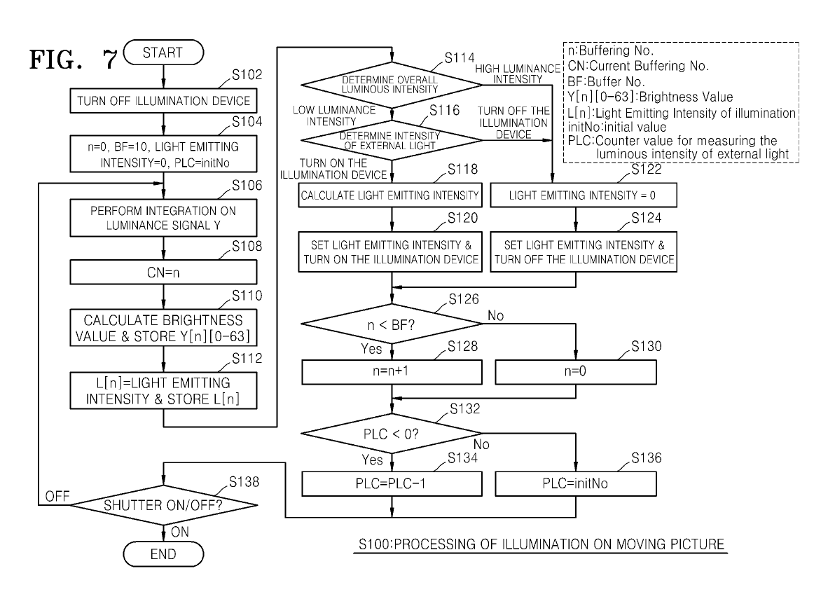

FIG. 6 is a timing diagram for illustrating an example of a signal synchronization method used by the synchronization circuit 1228, according to an embodiment of the present invention. That is, FIG. 6 illustrates signal synchronization of the imaging device 100. In detail, the timing diagram of FIG. 6 illustrates a vertical synchronization signal output from the timing generator 120 and a control signal output from the CPU 126, and the control signal synchronized by the synchronization circuit 1228.

As illustrated in FIG. 6, in general, a time when the magnitude of the control signal output from the CPU 126 changes is not synchronized with the vertical synchronization signal. The vertical synchronization signal shows a time of performing charge reading on the CCD 102 from upward to downward. Thus, when light emitting intensity changes between locations A where the charge reading begins, brightness level changes according to a change in the light emitting intensity during an image display, e.g., the bottom half of an image becomes brighter than the top half thereof. Thus, a time of changing the light emitting intensity in response to the control signal output from the CPU 126, must be synchronized with the time of performing charge reading in response to the vertical synchronization signal. Thus, the synchronization circuit 1228 synchronizes the control signal with the vertical synchronization signal, and supplies the synchronized control signal, as illustrated in FIG. 6, to the current control circuit 1230.

Referring back to FIG. 1, the CPU 126 can control the constitutional elements of the imaging device 100 or perform an arithmetic operation, based on a control program or an execution program stored in memory devices, such as the memory 132 and the recording medium 118. For example, for focus control or exposure control, the CPU 126 can control the operation of a focusing optical system by supplying a control signal to a driving device (not shown) of the focusing optical system. Also, the CPU 126 can control the constitutional elements of the imaging device 100 through user control by using the shutter 128 or an operating unit (not shown), such as a dial for adjustment. Also, the CPU 126 has functions of determining overall luminous intensity, determining the luminous intensity by external light, and calculating light emitting intensity based on a program stored in a predetermined memory unit, as will be described later in detail.

The shutter 128 is a unit via which a user informs the imaging device 100 of a time of photographing. The shutter 128 is an example of a user control interface. For example, manipulation through the shutter 128 may be delivered to the CPU 126.

The memory 132 can be used as cache memory in order to store a control or execution program which regulates the operation of the CPU 126, or to perform calculations using the CPU 126. Also, the memory 132 can store either an image signal generated by the image input controller 108 or image data generated by the image signal processor 114. A light emitting intensity of the light source 124 and a luminance signal measured by photographing and illuminating a subject on the light emitting intensity may be related to each other and be stored.

In order to capture a moving picture, the memory 132 temporarily stores a moving picture frame (image data) captured through time sharing, and stores moving picture data generated by the image signal processor 114 based on the moving picture frame. However, if the moving picture frame is written directly to the moving picture memory 204, the moving picture frame may not be stored in the memory 132. Also, if the read/write operation of the memory 132 is faster than that of the moving picture memory 204, the memory 132 can be used as cache memory. For example, the memory 132 may be a semiconductor memory device, such as synchronous dynamic random access memory (SDRAM).

The memory 132 may include a ring buffer with two or more data storage regions. The ring buffer is data memory in which a plurality of data storage regions are arranged in a ring fashion. For example, the total number of data storage regions (the total number of buffers) is BF (=10) and the buffering number n is sequentially allocated to the data storage regions. Data is sequentially stored in the ring buffer according to the buffering number n. However, once data is stored in the data storage region with the buffering number n=BF, subsequent data is stored in the first data region with the buffering number n=0. That is, since the ring buffer has a ring shape, sequential data is overwritten in the most previously written data storage region when data is to be stored in a last data storage region.

The compression processor 134 compresses image data or moving picture data by encoding the image data or the moving picture. The compression processor 134 compresses image data read from the memory 132 or the moving picture memory 204, moving picture data, or image data or moving picture data input through the image signal processor 114. For example, when receiving image data, the compression processor 134 may compress the image data in a compression format, e.g., JPEG or LZW. Also, when receiving moving picture data, the compression processor 134 may compress the moving picture data by encoding the differences between moving picture frames while encoding the moving picture frames.

The video encoder 136 converts received image data in a format so that the image data can be displayed on the image display unit 138. For example, the video encoder 136 can read and perform conversion on image data for live view stored in the memory 132 or the moving picture memory 204, image data in various setting images, or image data stored in the recording medium 118. Also, image data converted by the video encoder 136 is supplied to the image display unit 138. And the image display unit 138 displays the image data received from the video encoder 136. For example, the image display unit 138 may be a display device, such as a liquid crystal display (LCD) or an electro luminescence display (ELD).

The moving picture sequencer 202 controls reading of a moving picture frame from the moving picture memory 204, or writing of image data, obtained from the image signal processor 114, to the moving picture memory 204. In particular, the moving picture sequencer 202 can manage which data storage region is to be accessed from among the data storage regions of the moving picture memory 204. Thus, the moving picture sequencer 202 can actually control reproduction of moving picture data. Accordingly, the moving picture sequencer 202 may be an example of a frame recording unit or a moving picture reproducing unit.

When reproducing a moving picture, the moving picture sequencer 202 reads moving picture frames from the data storage regions of the moving picture memory 204 in a predetermined order, and inputs them to the video encoder 136. For example, if the moving picture memory 204 includes two data storage regions (A and B regions), the moving picture sequencer 202 displays moving picture data, which was recorded on the B region, on the image display unit 138 by supplying the moving picture data to the video encoder 136 while recording moving picture frames on the A region. Also, the moving picture sequencer 202 displays moving picture data, which was recorded on the A region, on the image display unit 138 by supplying the moving picture data to the video encoder 136 while recording moving picture frames on the B region. By repeating the above process, the moving picture sequencer 202 can directly display a captured moving picture on the image display unit 138 during capturing.

The moving picture sequencer 202 may write a new moving picture frame on a previous moving picture frame without updating a data storage region on which moving picture frames are recorded. In this case, it is possible to consecutively display moving picture frames recorded on a data storage region other than a data storage region on which previous moving picture frames are recorded, and to remove the previous moving picture frames without reproducing them. Based on the above principle, during the determination of luminous intensity, the moving picture sequencer 202 can erase only a moving picture frame of a subject, on which light having different intensities is incident. In this way, it is possible to skip an unnecessary process to erase moving picture frames.

The moving picture memory 204 is a device storing moving picture frames, and is referred to as ‘video random access memory (VRAM)’. In the moving picture memory 204, a plurality of data storage regions are arranged. In each of the data storage regions, moving picture frames are stored units of frames in a predetermined order.

For example, if the moving picture memory 204 includes two data storage regions, e.g., A and B regions, moving picture frames are alternately stored in the two data storage regions. The stored moving picture frames are alternately read from the two data storage regions by the moving picture sequencer 202, and displayed as a moving picture on the image display unit 138. For example, a first moving picture frame is recorded on the A region, a second moving picture frame is recorded on the B region, and a third moving picture frame is recorded on the A region. In this case, the first moving picture can be read and displayed while recording the second moving picture frame. Also, a new moving picture frame overwrites a previous moving picture frame without updating a data storage region, thereby preventing the previous moving picture frame from being displayed.

The imaging device 100 according to the current embodiment has been described above, but a description of some of the operations of the CPU 126 of the imaging device 100 is omitted. Also, a description of some of the operations of the illumination intensity controller 122, which are related to the omitted operations of the CPU 126, is also omitted. Therefore, such omitted operations will now be described hereinafter in greater detail.

Moving Picture Backlight Compensation

First, an example of a method of processing illumination on a moving picture in the imaging device 100 will be described with reference to FIG. 7. FIG. 7 is a flowchart illustrating a method S100 of processing illumination on a moving picture in the imaging device 100, according to an embodiment of the present invention. The method S100 relates to processing the luminous intensity of a subject, and particularly, includes determining luminous intensity by distinguishing between the effect of illumination from the light source 124 of the imaging device 100 illustrated in FIG. 1 and the effect of illumination from external light.

As illustrated in FIG. 7, in operation S102, illumination from the light source 124 is “off”, i.e., the light source 124 is switched off, in the imaging device 100. Then, in operation S104, the imaging device 100 determines a buffering number n(=0), the total number of buffers BF (=10), an initial value of light emitting intensity (=0), and a counter value PLC (=initNo) for measuring the luminous intensity by external light. Then, in operation S106, the imaging device 100 performs integration on a luminance signal Y by means of the light measuring unit 112. In operation S108, the imaging device 100 sets a current buffering number CN to be equal to the buffering number n.

Then, in operation S110, the imaging device 100 calculates brightness values of image regions 0 through 63, and stores the brightness values as an arrangement of Y[n][0] through Y[n][63] corresponding to the buffering number n. In operation S112, the imaging device 100 stores the light emitting intensity as an arrangement of L[n] corresponding to the buffering number n. In operation S114, the imaging device 100 determines whether overall luminous intensity is high or low by determining overall luminous intensity using the CPU 126. If the overall luminous intensity is determined to be high, the imaging device 100 performs operation S122. Otherwise, if the overall luminous intensity is determined to be low, the imaging device 100 performs operation S116. The determination of overall luminous intensity will be described later in detail.

In operation S116, the imaging device 100 determines whether to turn on or off the light source 124 by determining the luminous intensity by external light in the CPU 126. If the light source 124 is determined to be turned on, the imaging device 100 performs operation S118. Otherwise, if the light source 124 is determined to be turned off, the imaging device 100 performs operation S122. A method of determining the luminous intensity by external light will be later described in detail.

In operation S118, the imaging device 100 calculates light emitting intensity of light source in the CPU 126. A method of calculating the light emitting intensity of light source will also later be described in detail. In operation S120, the imaging device 100 sets light emitting intensity of light source and turns on the light source 124. In operation S122, the imaging device 100 sets light emitting intensity to ‘0’. In operation S124, the imaging device 100 sets light emitting intensity and turns off the light source 124.

In operation S126, the imaging device 100 compares the buffering number n with the total number of buffers BF in order to determine whether the buffering number n is less than the total number of buffers BF. If the buffering number n is less than the total number of buffers BF, the imaging device 100 performs operation S128. Otherwise, the imaging device 100 performs operation S130. In operation S128, the imaging device 100 increases the buffering number n by 1 (n=n+1). In operation S130, the image device 100 sets the buffering number n to ‘0’ (n=0).

In operation S132, the image device 100 determines whether the counter value PLC for measuring the luminous intensity by external light is greater than ‘0’. More specifically, the imaging device 100 determines whether the counter value PLC is less than 0. If the counter value PLC is less than 0, the imaging device 100 performs operation S134. Otherwise, the imaging device 100 performs operation S136.

In operation S134, the imaging device 100 reduces the counter value PLC by 1 and set PLC to the reduced value (PLC=PLC−1). In operation S136, the image device 100 sets an initial value initNo to the counter value PLC.

In operation S138, the image device 100 determines whether the shutter 128 is turned on or off. If the shutter 128 is turned on, the imaging device 100 ends the method S100. Otherwise, if the shutter 128 is turned off, the imaging device 100 performs operation S106. Thus, the method S100 is performed when the shutter 128 is turned on, and preview images can be displayed before turning on the shutter 128.

Operations S114 through S118 of the method S100 will now be described in greater detail. Operations S114 through S118 may be performed mainly using the functions of the CPU 126 of determining overall luminous intensity, determining the luminous intensity by external light, and calculating light emitting intensity.

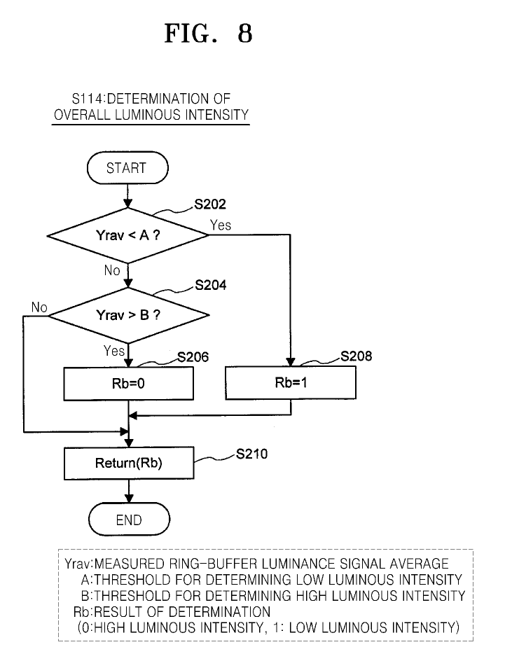

FIG. 8 is an example of a flowchart illustrating operation S114 of determining overall luminous intensity, according to an embodiment of the present invention. Operation S114 is performed mainly using the function of the CPU 126: determining overall luminous intensity.

In this embodiment, overall luminous intensity must be understood to include not only the effect of illumination from an imaging device but also the effect of illumination from external light. For example, a measured ring-buffer luminous intensity average Yrav may be expressed by Equation (2) below. In Equation (2), a measured luminous intensity average Yaa is an average of luminous intensities Y of all the image regions of the CCD 102 and is expressed by Equation (3) below. Thus, the measured ring-buffer luminous intensity average Yrav is an average of luminous intensities measured in all the image regions of the CCD 102 with respect to the total number frames stored in ring buffers.

$$\begin{matrix}Yrav = \frac{1}{10} {\sum }_{n = 0}^{9} Yaa [ n ] & ( 2 ) \\ Yaa [ n ] = \frac{1}{64} {\sum }_{i = 0}^{63} ( Y [ n ] [ i ] ) & ( 3 )\end{matrix}$$

As illustrated in FIG. 8, In operation S202, the image device 100 compares the measured ring-buffer luminous intensity average Yrav with a low luminous intensity threshold A in order to determine whether the measured ring-buffer luminous intensity average Yrav is less than the low luminous intensity threshold A. If whether the measured ring-buffer luminous intensity average Yrav is less than the low luminous intensity threshold A, the imaging device 100 performs operation S208. Otherwise, the imaging device 100 performs operation S204.

In operation S204, the image device 100 compares the measured ring-buffer luminous intensity average Yrav with a high luminous intensity threshold B in order to determine whether the measured ring-buffer luminous intensity average Yrav is greater than the high luminous intensity threshold B. If the measured ring-buffer luminous intensity average Yrav is greater than the high luminous intensity threshold B, the imaging device 100 performs operation S206. Otherwise, the imaging device 100 performs operation S210.

In operation S206, the image device 100 substitutes a variable Rb, representing the result of determining overall luminous intensity, with ‘0’ to represent that overall luminous intensity is high. In operation S208, the image device 100 substitutes the variable Rb with ‘1’ to represent that overall luminous intensity is low. In operation S210, the image device 100 outputs the variable Rb.

As described above, when overall luminous intensity is less than the low luminous intensity threshold A, the luminous intensity is determined to be low, and when the overall luminous intensity is greater than the high luminous intensity threshold B, the luminous intensity is determined to be high.

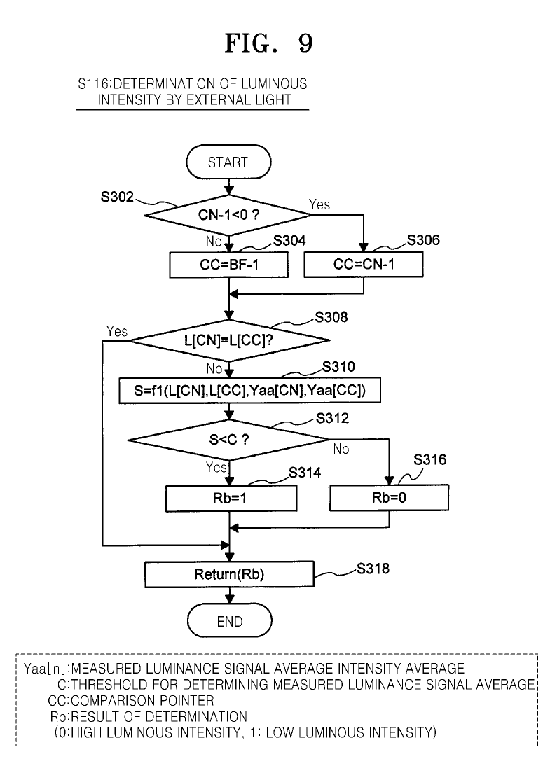

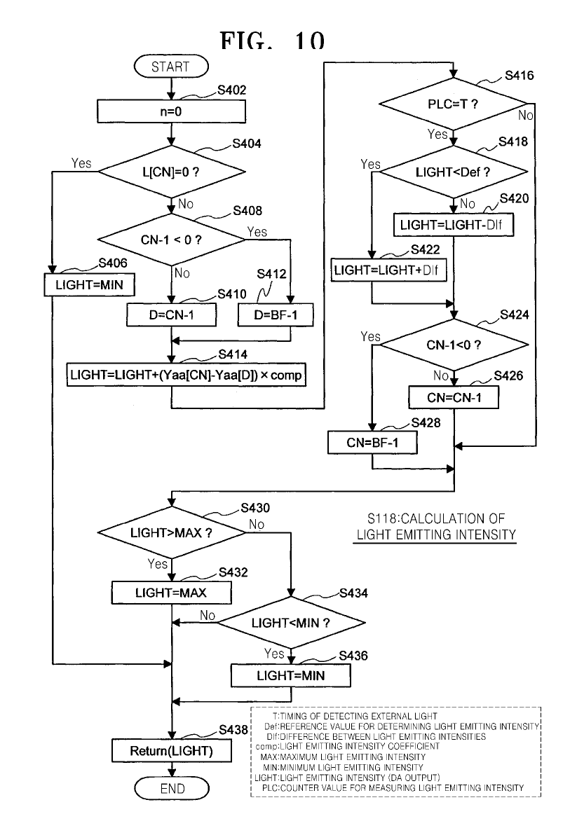

FIG. 9 is a flowchart illustrating an example of operation S116 of determining the luminous intensity by external light, according to an embodiment of the present invention. Operation S116 is performed mainly using the function of the CPU 126: determining of the luminous intensity by external light.

As illustrated in FIG. 9, in operation S302, the imaging device 100 determines whether current buffering number CN is equal to ‘0’. That is, the imaging device 100 determines CN−1<0. If CN−1<0, the imaging device 100 performs operation S306. Unless CN−1<0, the imaging device 100 performs operation S304.

In operation S304, the image device 100 substitutes the result of subtracting ‘1’ from the total number of buffers BF, i.e., BF−1, into a comparison pointer CC. In operation S306, the image device 100 substitutes the result of subtracting ‘1’ from the current buffering number CN, i.e., CN−1, into the comparison pointer CC. In operation S306, buffering number CN−1 right before the current buffering number CN is substituted into the comparison pointer CC.

In operation S308, the imaging device 100 compares a light emitting intensity L[CN] corresponding to the current buffering number CN with a light emitting intensity L[CC] corresponding to the comparison pointer CC in order to determine whether L[CN]=L[CC]. If L[CN]=L[CC], the imaging device 100 performs operation S318. Otherwise, the imaging device 100 performs operation S310.

In operation S310, the image device 100 substitutes the luminous intensity by external light f into a variable S. The luminous intensity by the external light f is calculated using as factors the light emitting intensity L[CN] and a measured luminance signal average Yaa[CN] corresponding to the current buffering number CN and the light emitting intensity L[CC] and a measured luminance signal average Yaa[CC] corresponding to the comparison pointer CC. The measured luminance signal f can be expressed as the following Equation (4):

$$f = Yaa [ CN ] - \frac{Yaa [ CN ] - Yaa [ CC ]}{L [ CN ] - L [ CC ]} \times L [ CN ] \qquad ( 4 )$$

Then, in operation S312, the imaging device 100 compares the variable S with a measured luminous signal threshold C in order to determine if the variable S is less than the measured luminance signal threshold C. If the variable S is less than the measured luminance signal threshold C, the imaging device 100 performs operation S314. Otherwise, the imaging device 100 performs operation S316.

In operation S314, the image device 100 substitutes a variable Rb, representing that luminous intensity by external light is low, with ‘1’. In operation S316, the image device 100 substitutes the variable Rb with ‘0’ to represent that luminous intensity by external light is high. In operation S318, the image device 100 outputs the variable Rb. If Rb=0, the imaging device 100 determines that the light source 124 may be turned on. Otherwise, if Rb=1, the imaging device 100 determines that the light source 124 needs to be turned off.

As described above, the imaging device 100 can determine the luminous intensity by external light based on the measured luminance signal of image signal forming by photographing a subject on which light having different intensities is incident. For example, the imaging device 100 determines that luminous intensity by external light is high when the measured intensity S (or f) of external light is greater than a predetermined measured luminous signal threshold CC.

Operation S118: Calculation of Light Emitting Intensity

FIG. 10 is a flowchart illustrating an example of operation S118 of calculating light emitting intensity in the imaging device 100, according to an embodiment of the present invention. Operation S118 is performed by mainly using the function of the CPU 126: calculating light emitting intensity.

Referring to FIG. 10, in operation S402, the imaging device 100 sets the buffering number n to ‘0’. In operation S404, the imaging device 100 determines whether the light emitting buffer L[CN] corresponding to the current buffering number CN is ‘0’. If L[CN]=0, the imaging device 100 performs operation S406. Otherwise, the imaging device 100 performs operation S408.

In operation S408, the image device 100 determines whether the current buffering number CN is ‘0’, i.e., CN−1<0. If CN−1<0, the imaging device 100 performs operation S412. Otherwise, the imaging device 100 performs operation S410.

In operation S410, the image device 100 substitutes the result of subtracting ‘1’ from the buffering number CN, i.e., CN−1, into a variable D. In operation S412, the image device 100 substitutes the result of subtracting ‘1’ from the total number of buffers BF, i.e., BF−1, in the variable D. The variable D denotes the buffering number representing a data storage region storing data, which precedes the current buffering number CN.

In operation S414, the image device 100 adds the result of allocating a weight to the difference between a measured luminous signal average Yaa[CN] corresponding to the current buffering number CN and a measured luminance signal average Yaa[D] corresponding to the variable D, i.e., (Yaa[CN]−Yaa[D])×comp), to the difference, and then substitutes the result value into a variable LIGHT representing light emitting intensity. Here, ‘comp’ denotes a light emitting intensity coefficient, e.g., a predetermined constant.

In operation S416, the imaging device 100 compares a counter value PLC for measuring the luminous intensity by external light with a time T of detecting external light in order to determine whether the counter value PLC is equal to the time T. If the counter value PLC is equal to the time T, the imaging device 100 performs operation S418. Otherwise, the imaging device 100 performs operation S430. The time T of detecting external light denotes a time that the luminous intensity by external light is determined to be high. Thus, the counter value PLC is equal to the time T, the luminous intensity by external light is determined to be high.

In operation S418, the image device 100 compares the parameter LIGHT with a predetermined value Def in order to determine whether the parameter LIGHT is less than the predetermined value Def. If the parameter LIGHT is less than the predetermined value Def, the imaging device 100 performs operation S422. Otherwise, the imaging device 100 performs operation S420. The predetermined value Def is a constant that is a reference value for determining the parameter LIGHT referring to luminous emitting intensity. For example, the predetermined value Def is set to be equal to the sum of a maximum light emitting intensity MAX and a minimum light emitting intensity MIN, divided by two, i.e., ((MAX+MIN)/2).

In operation S420, the image device 100 substitutes the result of subtracting a predetermined value Dif from the parameter LIGHT, i.e., (LIGHT−Dlf), into the parameter LIGHT. In operation S422, the image device 100 substitutes the result of adding the predetermined value Dlf to the variable LIGHT, i.e., (LIGHT+Dlf), into the parameter LIGHT. The predetermined value Dlf is the difference between light emitting intensities when lights having different intensities are emitted during a duration corresponding to one frame. In detail, the predetermined value Dlf is a constant representing light emitting intensity having different intensity for determination of luminous intensity.

In operation S424, the image device 100 determines whether the current buffering number CN is ‘0’. In detail, the imaging device 100 determines whether CN−1<0. If CN−1<0, the imaging device 100 performs operation S428. Unless CN−1<0, the imaging device 100 performs operation S426.

In operation S430, the image device 100 compares the parameter LIGHT with the maximum light emitting intensity MAX in order to determine whether the parameter LIGHT is greater than the maximum light emitting intensity MAX. If the parameter LIGHT is greater than the maximum light emitting intensity MAX, the imaging device 100 performs operation S432. Otherwise, the imaging device 100 performs operation S434.

In operation S432, the image device 100 substitutes the maximum light emitting intensity MAX into the parameter LIGHT. In operation S434, the image device 100 compares the parameter LIGHT with the minimum light emitting intensity MIN in order to determine whether the parameter LIGHT is less than the minimum light emitting intensity MIN. If the parameter LIGHT is less than the minimum light emitting intensity MIN, the imaging device 100 performs operation S436. Otherwise, the imaging device 100 performs operation S438.

In operation S436, the image device 100 substitutes the minimum light emitting intensity MIN into the parameter LIGHT. In operation S438, the image device 100 outputs the parameter LIGHT. The parameter LIGHT is equivalent to the DA output of the control signal as illustrated in FIG. 5.

As described above, light emitting intensity is set according to the difference between adjacent measured luminance signals of central region in a ring buffer.

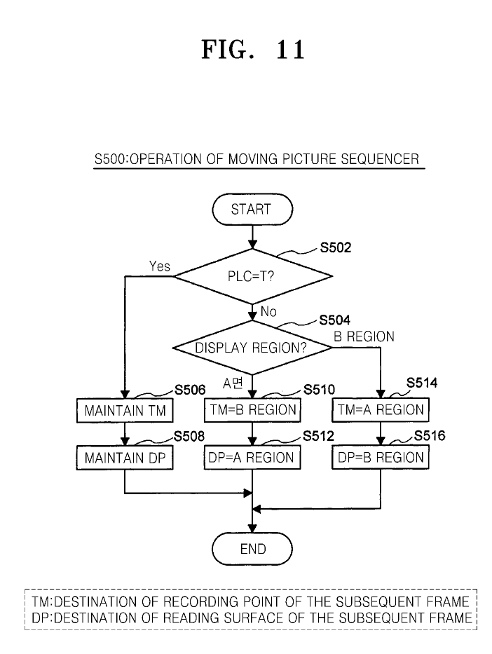

FIG. 11 is a flowchart illustrating in greater detail an example of an operation of the moving picture sequencer 202 of the imaging device 100 illustrated in FIG. 1, according to an embodiment of the present invention. As previously stated, the moving picture sequencer 202 performs a read/write operation while switching between the data storage regions, e.g., A and B regions, of the moving picture memory 204.

More specifically, as illustrated in FIG. 11, in operation S502, the moving picture sequencer 202 compares a counter value PLC for measuring the luminous intensity by external light with a time T of detecting external light in order to determine whether the counter value PLC is equal to the time T. If the counter value PLC is equal to the time T, the moving picture sequencer 202 performs operation S506. Otherwise, the moving picture sequencer 202 performs operation S504.

In operation S506, the moving picture sequencer 202 maintains a data storage region TM on which a subsequent frame is to be recorded (destination of recording point of the subsequent frame). In operation S508, the moving picture sequencer 202 maintains a data storage region DP from which a subsequent frame is to be read (destination of reading surface of the subsequent frame).

In operation S504, the moving picture sequencer 202 determines whether a data storage region storing a currently displayed frame (display surface) is the A or B region. If the display surface is the A region, the moving picture sequencer 202 performs operation S510. Otherwise, if the display surface is the B region, the moving picture sequencer 202 performs operation S514.

In operation S510, the moving picture sequencer 202 determines the destination TM to be B region. Also, in operation S512, the moving picture sequencer 202 determines the next surface DP to be the A region. In operation S514, the moving picture sequencer 202 determines the destination TM to be the A region. In operation S516, the moving picture sequencer 202 determines the next surface DP to be the B region.

The operation of the moving picture sequencer 202 has been described above in detail with a case where the moving picture memory 204 has two data storage regions, i.e., A and B regions. As described above, when the counter value PLC for measuring the luminous intensity by external light corresponds to the time T of detecting external light, in operation S500, the data storage regions of the moving picture memory 204 are not updated, thereby preventing the frame of a subject, on which light having different intensities is incident for the detection of luminous intensity, from being displayed.

As described above, the imaging device 100, according to an embodiment of the present invention, can determine the luminous intensity of a subject. Particularly, the imaging device can determine luminous intensity by distinguishing between illumination from the light source 124 and illumination from external light, and control the light source 124 to be turned off or reduce the light emitting intensity of the light source 124 based on the determination result. A summary of the operations of the imaging device 100 is as follows.

The imaging device 100 includes the light source 124 as an illumination device shedding light on a subject. Also, the imaging device 100 includes the moving picture sequencer 202 that is an image transmission device storing image data obtained through the CCD 102 and stored in the moving picture memory 204. The imaging device 100 also includes the light measuring unit 112 as a light measuring device measuring the brightness level of each of the image regions of the CCD 102. The imaging device 100 further includes the illumination intensity controller 122 as a light emitting intensity controller controlling the intensity of light emitted from the light source 124.

Also, the imaging device 100 includes the memory 132 in which a brightness level measured by the light measuring unit 112 and the light emitting intensity of the light source 124, which corresponds to the brightness level, are stored to be related to each other. Also, the imaging device 100 includes the image display unit 138 as a moving picture display device displaying image data corresponding to an image signal that is to be read at predetermined periods of time in synchronization with a vertical synchronization signal received from the CCD 102.

For example, the imaging device 100 can continuously display moving pictures while continuously lightening a subject by means of the light source 124. In this case, the imaging device 100 can change the light emitting intensity of the light source 124 for a duration corresponding to at least one frame by means of the illumination intensity controller 122. Thus, the imaging device 100 can calculate luminance signal of frame accepted by capturing a subject with external light by comparing luminance signal of a frame captured by changing the light emitting intensity of the light source 124 with frames captured before and after the frame. For example, it is possible to compare the luminous intensities of frames captured with illumination of different light emitting intensities, and turn off the light source 124 or reduce the light emitting intensity of the light source 124 based on the comparing result.

Also, the imaging device 100 includes the moving picture memory 204 storing a plurality of moving picture frames. The moving picture memory 204 has data storage regions in which moving picture frames are stored in units of frames. Thus, the moving picture sequencer 202 can display preview moving pictures by storing a new moving picture frame in a data storage region corresponding to a moving picture frame that is not displayed on the image display unit 138 and by displaying a moving picture frame, stored in another data storage region, on the image display unit 138.

As described above, the moving picture sequencer 202 can switch between the data storage regions of the moving picture memory 204 alternately or in a predetermined order. Also, the moving picture sequencer 202 can prevent a switch between the data storage regions from occurring so that a subsequent frame can be written to a previous frame in a data storage region storing a frame captured with lights having different intensities in order to determine luminous intensity.

The imaging device 100 can compare a first measured luminance signal when the light emitting intensity from the light source 124 has a predetermined level with a second measured luminance signal when the light emitting intensity from the light source 124 is less than the predetermined level. Also, the imaging device 100 can compare the first measured luminous signal with a third measured luminance signal when the light emitting intensity from the light source 124 is greater than the predetermined level. The imaging device 100 determines the effect of an illumination device to be low when the third measured luminance signal ≦ the first measured luminance signal or when the first measured luminance signal ≦ the second measured luminance signal, and thus turns off the light source 124.

The determination of luminous intensity by the imaging device 100 will now briefly described. In general, the imaging device 100 stands by until a user presses the shutter 128 while displaying a moving picture (preview image). The imaging device 100 records the frames of each preview moving picture in the data storage regions of the moving picture memory 204 in a predetermined order. For example, when the moving picture memory 204 has two data storage regions, the imaging device 100 forms a preview image by repeatedly displaying frames while switching between the two data storage regions, i.e., a write region and a read region, in units of frames.

While forming the preview image, the imaging device 100 generates a luminance signal Y from RGB signals with respect to a predetermined image region of the CCD 102, and calculates the luminous intensity corresponding to one frame by performing integration on each of the image regions in units of pixels. The imaging device 100 monitors a measured luminance signal average stored in a ring buffer included in the memory 132 while storing luminance signal in the ring buffer in units of frames. Also, if a preview image is dark, luminance signal is low, and a brightness level at which the preview image cannot be viewed is set to a first threshold. The luminance signal is compared with the threshold, and an illumination device is turned on when the luminance signal is smaller than the first threshold.

After the illumination device is turned on, the imaging device 100 can determine whether the illumination device is to be kept turned on or is to be turned off at a predetermined time or predetermined periods of time by using the functions of the CPU 126: determination of overall luminous intensity and determination of the luminous intensity by external light. For example, the illumination device is turned off when the measured luminance signal while the illumination device is turned on is far greater than a predetermined threshold (second threshold). For example, the first threshold is less than the second threshold. In this way, it is possible to prevent the phenomenon that an illumination device is repeatedly turned on and turned off, i.e., hunting, from occurring.

However, the light emitting intensity of the illumination device depends on the distance between the imaging device 100 and a subject or the rate of reflection from the subject. Thus, the second threshold must be determined to have a very large value. In this case, a duration that the illumination device is turned on is long, and thus, increasing power consumption of the imaging device 100. Accordingly, the luminous intensity only from external light and not from an illumination device must be considered in determining whether to turn off the illumination device.

As previously described, the luminous intensity of a subject when an illumination device is turned on is largely divided into the luminous intensity of the illumination device and the luminous intensity by external light. When the luminous intensity by external light is sufficiently high, a subject does not need to be illuminated using the light source 124, and the imaging device 100 may turn off the light source 124. Accordingly, the light emitting intensity from an illumination device, and the luminous intensity by external light need to be separated from luminous intensity measured when the illumination device is turned on.

However, it is impossible to separate the intensities of the emitted light and the external light from the measured luminance signal. Therefore, during the capturing of a moving picture, the light emitting intensity is calculated by changing the light emitting intensity from an illumination device with respect to one frame, and comparing the luminance signal of the frame with those of frames before and after the frame. Also, the frame subsequent to the frame captured by changing the light emitting intensity is captured using the original light emitting intensity.

Accordingly, the imaging device 100 determines whether to turn off the light source 124 (or to reduce the light emitting intensity of the light source 124) based on the luminous intensity by external light, which is calculated by subtracting the calculated the light emitting intensity from the measured luminance signal. Also, the imaging device 100 is designed to determine the light source 124 not to be effective when the calculated the light emitting intensity is lower than a predetermined level, and to turn off the light source 124 (or reduce the light emitting intensity of the light source 124) accordingly. A change in the light emitting intensity results in a change in the brightness level of the moving picture. In this case, a frame having a different brightness level appears during reproduction of the moving picture, and thus, the moving picture becomes impure. Thus, the imaging device 100 may not display the frame captured by changing the light emitting intensity of the illumination device on the image display unit 138.

Accordingly, the light emitting intensity of the light source 124 can be appropriately controlled, thereby saving power consumption of the imaging device 100. Also, it is possible to prevent a moving picture from becoming impure. Furthermore, it is possible to prevent hunting from occurring.

In the above embodiments of the present invention, although not shown in the drawings, a focusing optical system that focuses incident light on the CCD 102 may be installed at the head of the CCD 102 of the imaging device 100. In general, the focusing optical system may include a lens unit, a zoom unit, a focus unit, an iris unit, and a cylindrical barrel for mounting a lens. The focus unit includes a focusing lens. The iris unit adjusts the direction or range of light by changing the size of an aperture thereof. Also, the zoom unit, the focus unit, and the iris unit may be driven by a motor driver installed separately from them. For example, the focusing optical system may include a single focusing lens or a zoom lens.

As described above according to the above embodiments of the present invention, an imaging device can sense whether an illumination device is unnecessary by measuring the luminous intensity by external light and control the illumination device based on the sensing result.

While this invention has been particularly shown and described with reference to exemplary embodiments thereof, it will be understood by one skilled in the art that various changes in form and details may be made therein without departing from the spirit and scope of the invention as defined by the appended claims.

What is claimed is:

1. An imaging device comprising:
an imaging unit detecting luminous intensity;
a light emitting unit for emitting light on a subject while the imaging unit continuously detects the luminous intensity for a number of times;
a light measuring unit for detecting a brightness level of the subject according to the luminous intensity detected by the imaging unit; and
a light emitting intensity controller for controlling the intensity of light emitted from the light emitting unit,
wherein the light emitting intensity controller controls the light emitting unit to emit light having different intensities on the subject while the imaging unit detects the luminous intensity at least once, and reduces the light emitting intensity of the light emitting unit or adjusts the light emitting intensity to a value based on the brightness level of the subject on which the light having different intensities is emitted.

2. The imaging device of claim 1, further comprising a luminous intensity calculation unit for calculating a luminous intensity by external light by excluding the luminous intensity of the light emitted from the light emitting unit from the luminous intensity detected by the imaging unit, based on the brightness level of the subject on which the light having different intensities is emitted,
wherein the light emitting intensity controller reduces the light emitting intensity or adjusts the light emitting intensity to the value based on the calculated luminous intensity by external light.

3. The imaging device of claim 2, further comprising a moving picture reproduction unit for continuously displaying image frames obtained based on brightness levels corresponding to luminous intensities being continuously detected by the imaging unit for the number of times,
wherein the moving picture reproduction unit does not display an image frame corresponding to the brightness level of the subject on which the light having different intensities is emitted.

4. The imaging device of claim 3, further comprising:
a frame memory having a plurality of memory regions for storing the image frames; and
a frame recording unit for recording the image frames on the memory regions in a predetermined order,
wherein the frame recording unit overwrites a memory region, from among the memory regions, storing the image frame corresponding to the brightness level of the subject on which the light having different intensities is emitted with a subsequent image frame in the predetermined order, and
the moving picture reproduction unit displays the image frames stored in the memory regions in the predetermined order.

5. The imaging device of claim 1, wherein the value is zero.

6. The imaging device of claim 1, wherein the light emitting intensity controller comprises:
a synchronization circuit which synchronizes a synchronization signal with a control signal and outputs a synchronized control signal; and
a control circuit that controls the light emitting unit to emit the light based on the synchronized control signal.

7. The imaging device of claim 1, wherein:
the light measuring unit detects the brightness level of each of a plurality of image regions of the imaging unit by allocating a respective weight factor to each respective electrical signal output from each of the image regions.

8. The imaging device of claim 1, wherein:
the light emitting intensity controller reduces the light emitting intensity of the light emitting unit by stages until the light emitting intensity reaches a predetermined level.

9. The imaging device of claim 3, wherein:
the light emitting intensity controller reduces the light emitting intensity of the light emitting unit by one frame in synchronization with a vertical synchronization signal.

10. The imaging device of claim 1, wherein:
the imaging unit detects luminous intensity by distinguishing between an effect of illumination from the light emitting unit and an effect of illumination from external light.

11. An imaging method comprising:
operating an imaging unit to detect luminous intensity;
operating a light emitting unit to emit light on a subject while the imaging unit continuously detects the luminous intensity for a number of times;
detecting a brightness level of the subject according to the luminous intensity detected by the imaging unit; and
controlling the intensity of light emitted from the light emitting unit, by controlling the light emitting unit to emit light having different intensities on the subject while the imaging unit detects the luminous intensity at least once, and reducing the light emitting intensity of the light emitting unit or adjusting the light emitting intensity to a value based on the brightness level of the subject on which the light having different intensities is emitted.

12. The imaging method of claim 11, further comprising:
calculating a luminous intensity by external light by excluding the luminous intensity of the light emitted from the light emitting unit from the luminous intensity detected by the imaging unit, based on the brightness level of the subject on which the light having different intensities is emitted,
wherein the controlling step reduces the light emitting intensity or adjusts the light emitting intensity to the value based on the calculated the luminous intensity by external light.

13. The imaging method of claim 12, further comprising:
continuously displaying image frames obtained based on brightness levels corresponding to luminous intensities being continuously detected by the imaging unit for the number of times, and not displaying an image frame corresponding to the brightness level of the subject on which the light having different intensities is emitted.

14. The imaging method of claim 13, further comprising:
storing the image frames in a plurality of memory regions of a frame memory; and
recording the image frames on the memory regions in a predetermined order;
overwriting a memory region, from among the memory regions, storing the image frame corresponding to the brightness level of the subject on which the light having different intensities is emitted with a subsequent image frame in the predetermined order, and
displaying the image frames stored in the memory regions in the predetermined order.

15. The imaging method of claim 11, wherein the value is zero.

16. The imaging method of claim 11, wherein the controlling step comprises:
synchronizing a synchronization signal with a control signal and outputting a synchronized control signal; and
controlling the light emitting unit to emit the light based on the synchronized control signal.

17. The imaging method of claim 11, wherein:
the detecting step detects the brightness level of each of a plurality of image regions of the imaging unit by allocating a respective weight factor to each respective electrical signal output from each of the image regions.

18. The imaging method of claim 11, wherein:
the controlling step reduces the light emitting intensity of the light emitting unit by stages until the light emitting intensity reaches a predetermined level.

19. The imaging method of claim 13, wherein:
the controlling step reduces the light emitting intensity of the light emitting unit by one frame in synchronization with a vertical synchronization signal.

20. The imaging method of claim 11, wherein:
the step of operating the imaging unit operates the imaging unit to detect luminous intensity by distinguishing between an effect of illumination from the light emitting unit and an effect of illumination from external light.
